(19) United States
(12) Patent Application Publication
(10) Pub. No.: US 2012/0298455 A1
(43) Pub. Date: Nov. 29, 2012

(54) ACTUATION UNIT FOR AN ELECTROMECHANICALLY ACTUATED DISK BRAKE

(75) Inventors: Jens Bachon, Niedernhausen (DE); Holger Von Hayn, Bad Vilbel (DE)

(73) Assignee: CONTINENTAL TEVES AG & CO. OAG, Frankfurt (DE)

(21) Appl. No.: 13/577,339

(22) PCT Filed: Feb. 3, 2011
(86) PCT No.: PCT/EP11/51503

§ 371 Date: Aug. 6, 2012

(30) Foreign Application Priority Data
Feb. 16, 2010 (DE) 10 2010 001 986.0
Jan. 12, 2011 (DE) 10 2011 002 565.0

(51) Int. Cl. B60T 13/74

(52) U.S. Cl. 188/72.1

(57) ABSTRACT

An actuation unit for an electromechanically actuated disk brake for motor vehicles, arranged on a brake caliper (50) in which two brake linings (4, 5) interacting with lateral faces of a brake disk (6) are displaceable, one of the brake linings (4) being engageable by the actuation unit directly with the brake disk (6) by means of an actuating element (7). The actuation unit including an electric motor (1) and a reduction gear (2) operatively arranged between the electric motor (1) and the actuating element (7) and having a threaded spindle (17) which is driveable by the electric motor (1) and bears axially against the brake caliper (50). A rolling element bearing (33, 42, 63) and a force measuring device (30, 40, 60) having a deformable element (35, 43, 65) which is deformed when subjected to the force to be determined are arranged in the force flow between the threaded spindle (17) and the brake caliper (50). The threaded spindle (17) bearing against the deformable element of the force measuring device (30, 40, 60) via the rolling element bearing (33, 42, 63).

### CROSS-REFERENCE TO RELATED APPLICATIONS

This application claims priority to German Patent Application Nos. 10 2010 001 986.0, filed Feb. 16, 2010, 10 2011 002 565.0, filed Jan. 12, 2011, and PCT/EP2011/051503, filed Feb. 3, 2011.

### FIELD OF THE INVENTION

The invention relates to an actuation unit for an electromechanically actuated motor vehicle disk brake.

### BACKGROUND AND SUMMARY OF THE INVENTION

An electromechanically actuated disk brake consisting of a floating caliper and an actuation unit with an electric motor and a roller-and-thread drive arranged on the caliper is known from DE 196 52 230 A1. A force measuring device by means of which the application force of the brake can be determined is arranged in the force flow between the caliper and the actuation unit, the force measuring device being arranged in a bore of the threaded spindle.

WO 2004/083670 A1 discloses a generic actuation unit for an electromechanically actuated disk brake for motor vehicles, comprising an electric motor and a first reduction drive arranged operatively between the electric motor and an actuating element. A force measuring element may be arranged in the first reduction drive. More precise information on the arrangement and configuration of the force measuring element is not disclosed.

It is the object of the present invention to provide an actuation unit for an electromechanically actuated disk brake of the type mentioned in the introduction which has high accuracy in determining the application force while being configured to be as simple and cost-effective as possible with regard to production.

This object is achieved according to the invention by an actuation unit for an electromechanically actuated disk brake as claimed herein.

The invention is based on the concept that a rolling element bearing and a force measuring device comprising at least one deformable element which deforms when subjected to the force to be determined are arranged in the force flow between the threaded spindle and the brake caliper, the threaded spindle bearing against the deformable element of the force measuring device via the rolling element bearing. A simple and compact structure is thereby achieved.

The rolling element bearing is preferably in the form of a needle roller bearing. In the event of failure of the electro-mechanically actuated brake, the residual clamping force which is retained is thereby significantly reduced.

According to an alternative preferred embodiment of the invention, the rolling element bearing is in the form of a tapered roller bearing or a ball bearing. Because tapered roller bearings and ball bearings have a lower coefficient of friction, the attainable residual clamping force can be further reduced.

According to a preferred development of the invention, at least a part of the deformable element of the force measuring device is in the form of at least a part of the rolling element bearing. Through this “dual use” of the deformable element a reduced overall length can be achieved. In addition, the reduction of components achieved thereby leads to a cost optimization. As a result of the reduced number of components, any contour deviations on the contact surfaces occur less frequently or have a smaller influence, increasing the accuracy of the force measurement. Especially preferably, a part of the deformable element of the force measuring device and a part of the rolling element bearing are formed in one piece.

In the case of a rolling element bearing with a first and a second bearing element between which rolling elements are arranged, a part of the deformable element of the force measuring device is preferably in the form of one of the bearing elements of the rolling element bearing. A contact surface between bearing element and deformable element of the force measuring device is thereby eliminated.

Correspondingly, in the case of a needle roller bearing with bearing disks, a part of the deformable element of the force measuring device is preferably in the form of a bearing disk of the needle roller bearing.

In the case of a tapered roller bearing or a ball bearing as the rolling element bearing, a part of the deformable element of the force measuring device is preferably in the form of a ball bearing ring of the ball bearing or a tapered roller bearing ring of the tapered roller bearing.

In order to measure the deformation of the deformable element, which represents a measure for the application force of the brake, deformation sensors, for example in the form of strain gauges, are advantageously arranged on the deformable element.

An advantage of the invention is that increased accuracy in determining the application force is attained. A simplified production process and/or a reduction in production cost is/are thereby also achieved.

A further advantage of the invention is that a shorter overall length is achieved by combining force measuring device and bearing. The production costs for the actuation unit are also reduced by the smaller number of components. Furthermore, the influence of production inaccuracies is reduced. This increases the accuracy of the force measuring device and therefore of the determination of the application force.

According to a further preferred embodiment of the invention, the reduction gear is in the form of a rolling body-and-thread drive, in particular a ball screw drive, with a threaded spindle driveable by means of the electric motor.

It is also preferred that the actuation unit includes a second reduction gear, for example a rotation/rotation gear, arranged between the electric motor and a part of the reduction gear.

### BRIEF DESCRIPTION OF THE DRAWINGS

Further preferred embodiments of the invention are apparent from the dependent claims and from the following description with reference to figures, in which:

FIG. 1 shows schematically an electromechanically actuated disk brake in accordance with the prior art,

FIG. 2 shows schematically a partial view of a first exemplary embodiment of an actuation unit according to the invention for an electromechanically actuated disk brake,

FIG. 3 shows schematically a partial view of a second exemplary embodiment of an actuation unit according to the invention for an electromechanically actuated disk brake, and

FIG. 4 shows schematically a partial view of a third exemplary embodiment of an actuation unit according to the invention for an electromechanically actuated disk brake.

### DETAILED DESCRIPTION OF THE INVENTION

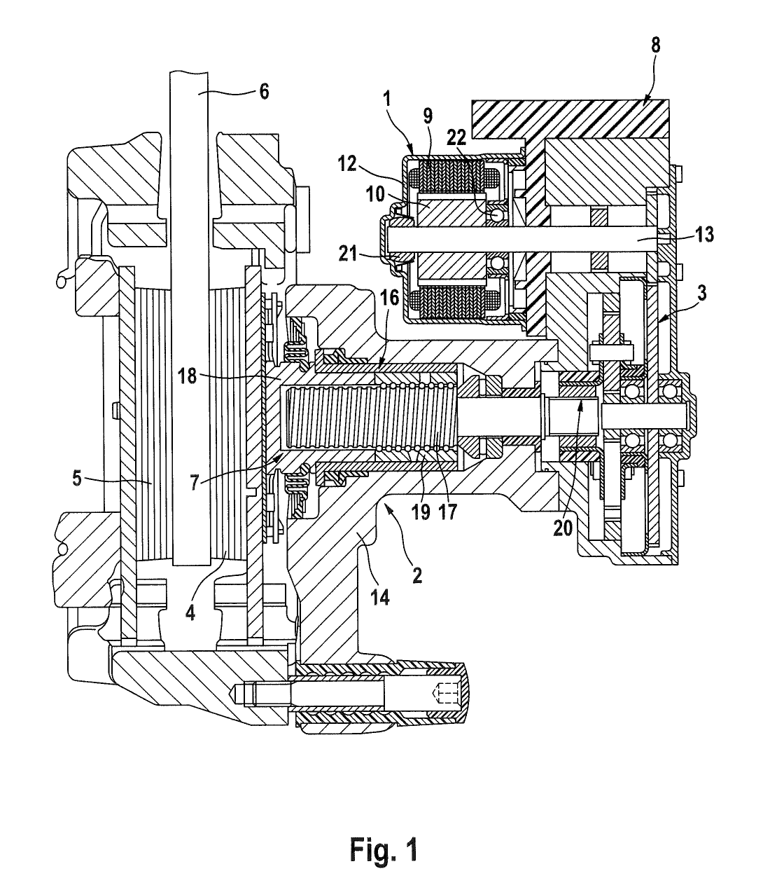

FIG. 1 shows an electromechanically actuated brake known from WO 2004/083670 A1, the caliper of which, shown in cross section, is mounted displaceably in a fixed support. A pair of friction linings (or pads) 4 and 5 is arranged in the brake caliper in such a way that they face towards the left-hand and right-hand lateral faces of a brake disk 6. While the first friction lining 4 can be brought directly into engagement with the brake disk 6 by an actuation unit by means of an actuating element 7, the second brake lining 5 is pressed against the opposite lateral face of the brake disk 6 through the effect of a reaction force exerted by the caliper upon actuation of the arrangement.

The actuation unit, which is mounted on the brake caliper by means of fastening means (not shown), has a modular structure and consists essentially of four independent assemblies or modules, namely a drive unit 1, a first reduction gear 2 actuating the first friction lining 4 and simultaneously converting a rotary motion into a translational motion, a second reduction gear 3 interposed between the drive unit 1 and the first reduction gear 2, and an electronic control unit 8 (or ECU-only the mounting for electronic components is shown).

The drive unit consists of an electric motor 1, the stator 9 of which is arranged immovably in a motor housing 12 and the rotor 10 of which is connected to a shaft 13 which is operatively connected to the second reduction gear 3. The first reduction gear 2 is in the form of a ball screw drive which is arranged in a transmission housing 14. The ball screw drive consists in this case of a threaded nut 16 and a threaded spindle 17, a plurality of balls, not designated in detail, being arranged between the threaded nut 16 and the threaded spindle 17, circulating during rotary motion of the threaded spindle 17 and imparting an axial or translational motion to the threaded nut 16. The threaded nut 16 has a two-part configuration and consists of a first part 18, which forms the aforementioned actuating element 7, and a second part 19 in which a recirculation region for the balls is formed, in which the balls can roll back without load to the start of the load-bearing track. The second reduction gear 3 is in the form, in the example, of a planetary gear set.

The arrangement is implemented in such a way that the rotor 10 or the shaft 13 of the electric motor drives the threaded spindle 17 via the interposed second reduction gear 3, while the first part 18 of the threaded nut 16 bears against the first friction lining 4. The coupling of the first reduction gear 2 to the second reduction gear 3 is effected by means of a plug-in connection without radial stress which carries reference numeral 20 and may be configured, for example, as a splined connection. Two radial bearings 21 and 22 arranged in the motor housing 12 serve to mount the rotor 10.

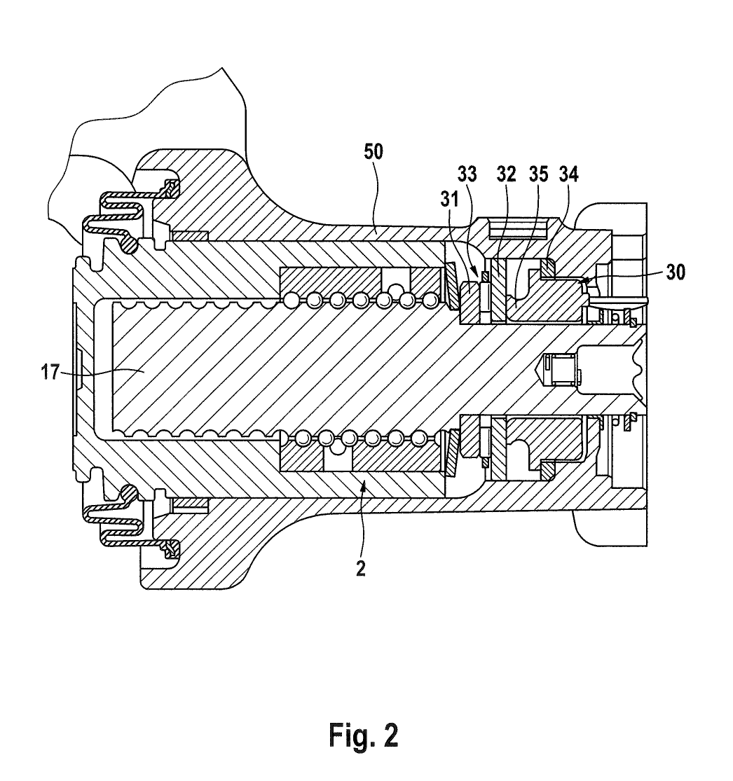

FIG. 2 shows schematically a partial view of a first exemplary embodiment of an actuation unit according to the invention for an electromechanically actuated disk brake. Here, the region of the reduction gear 2 which converts rotary motion into translational motion, and its support against the brake caliper 50, is shown on an enlarged scale. The threaded spindle 17 driven by electric motor 1 (not shown) bears against the brake caliper 50 via a needle roller bearing 33 and a force measuring device 30. The needle roller bearing 33 is arranged between the spindle 17 and the force measuring device 30 and serves, inter alia, to transmit force between the spindle 17 and a deformable element 35 of the force measuring device 30. The needle roller bearing 33 includes bearing disks 31 and 32. The force measuring device 30 bears against the brake caliper housing 50, via a further component 34 according to the exemplary embodiment in FIG. 2, and is arranged in particular rigidly, in particular non-rotatably, in the brake caliper (housing) 50. The bearing disk 32 and the deformable element 35 of the force measuring device 30 are hardened. A needle roller bearing 33 is advantageous because of the small amount of installation space available. Deformable element 35 is designed to deform in reaction to actuation forces exerted by the actuation unit and is measured by a strain measuring device such as electric resistance strain gages.

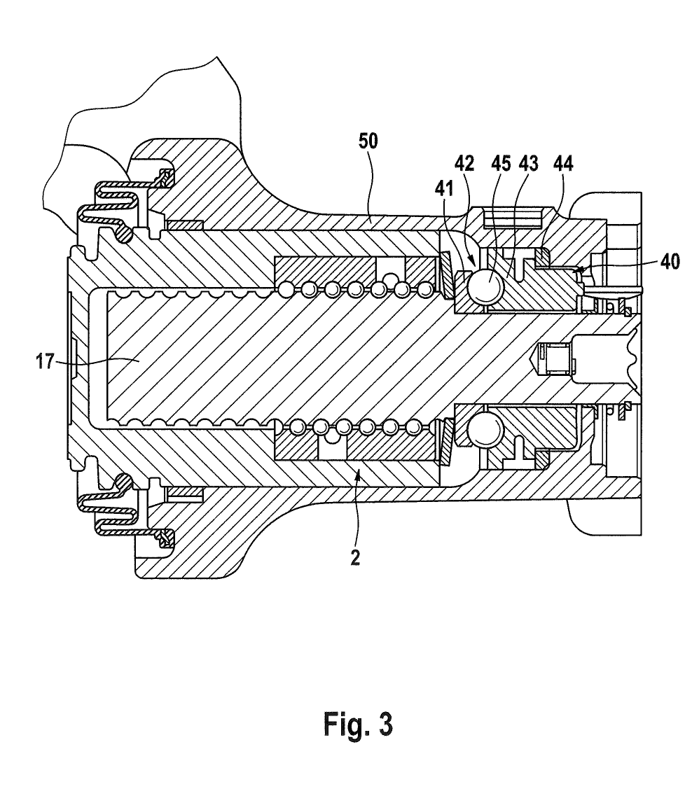

FIG. 3 shows schematically a partial view of a second exemplary embodiment of an actuation unit according to the invention for an electromechanically actuated disk brake. In this case the rolling bearing arranged between threaded spindle 17 and force measuring device 40 is in the form of a ball bearing 42. Alternatively, the rolling bearing may be in the form of a tapered roller bearing (not shown).

The arrangement of a ball bearing 42 or a tapered roller bearing in place of the needle roller bearing 33 is especially advantageous since ball and tapered roller bearings 42 inherently make possible a lower coefficient of friction. Needle roller bearings 33 inherently have a higher coefficient of friction, in particular when loaded with axial forces. The use of a ball or tapered roller bearing 42 therefore has the advantage that in the event of failure of the electromechanically actuated (service) brake the residual clamping force to be set can be reduced to a minimum. Above all, a ball bearing 42 has the further advantage of being very cost-effective in production.

Through their construction, ball and tapered roller bearings 42 have a larger space requirement than needle roller bearings 33. In order to reduce the space requirement, the force measuring device is advantageously configured in such a way that a part of the ball or tapered roller bearing, or the ball or tapered roller bearing itself, forms the deformable element 43 of the force measuring device 40.

In the second exemplary embodiment represented in FIG. 3, the ball bearing 42 is arranged between the threaded spindle 17 and the force measuring device 40, the ball bearing 42 serving to transmit force between threaded spindle 17 and force measuring device 40. The force measuring device 40 bears against the brake caliper housing 50, via a further component 44 according to this exemplary embodiment. The ball bearing 42 comprises a first bearing ring 41 and a second bearing ring 43, between which rolling balls 45 are arranged. The force measuring device 40 is configured in such a way that at least a part of its deformable element 43 forms part of the ball bearing 42, namely the outer bearing ring 43 of the ball bearing 42. Deformable element 43 features a circumferential groove as shown to promote desired deformation.

In an actuation unit according to the first exemplary embodiment (FIG. 2), the bearing disk 32 and the force measuring device 30 are in contact only via an annular edge (linear contact of the force measuring device 30), at least under low application forces. Through the production process of the bearing, the bearing disks 31, 32 and the deformable element 35, small contour deviations (regarding parallelism, flatness) within the range of a few pm are possible, with the result that the deformation of the deformable element 35 of the force measuring device 30 does not take place homogeneously or linearly, so that the output signal has deviations from the ideal characteristic curve. This can lead in some cases to slightly reduced accuracy of the application force measurement. In the second exemplary embodiment, in comparison to the first exemplary embodiment, the outer bearing disk and the linear contact with the force measuring device are eliminated, so that any contour inaccuracies of the bearing disk and of the linear contact can have no influence, or less influence, on the signal of the force measuring device 40. Accordingly, the measuring accuracy of the force measuring device 40 is increased according to the second exemplary embodiment.

Through the use of a conventional ball bearing 42 and the configuration of the deformable element 43 of the force measuring device 40 as a part of the ball bearing 42 (bearing ring 43), the residual clamping force in the event of failure of the electromechanically actuated brake can be reduced, while the overall length remains the same or is even reduced in comparison to the use of a needle roller bearing. Furthermore, the influence of contour inhomogeneities is reduced by the reduced number of components (through the at least partial “integration” or “combination” of bearing 42 and force measuring device 40), whereby the accuracy of the force measuring device is increased.

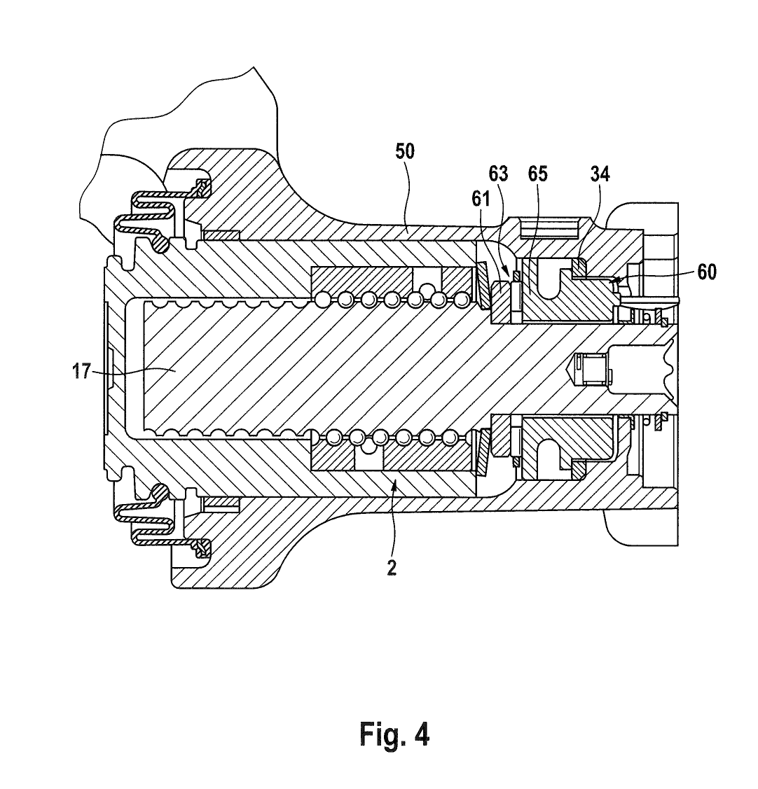

FIG. 4 shows schematically a partial view of a third exemplary embodiment of an actuation unit according to the invention for an electromechanically actuated disk brake. In this case the rolling bearing arranged between threaded spindle 17 and force measuring device 60 is in the form of a needle roller bearing 63. The needle roller bearing 63 includes a first bearing disk 61. The deformable element 65 of the force measuring device 60 is configured in such a way that it serves as the second bearing disk for the needle roller bearing 63. A needle roller bearing 63 is advantageous on account of the small installation space available. Through the configuration of the deformable element 65 of the force measuring device 60 as a part of the needle roller bearing (bearing disk), the number of components is reduced, reducing the influence of contour inhomogeneities. The accuracy of the force measuring device 60 can thereby be increased.

In the examples, the force measuring device 30, 40, 60 includes a deformable element, for example a deformable ring or a deformable disk made of steel on which electrical resistance strain gauges, for example made of silicon, are arranged to measure deformation.

While the above description constitutes the preferred embodiment of the present invention, it will be appreciated that the invention is susceptible to modification, variation, and change without departing from the proper scope and fair meaning of the accompanying claims.

1. An actuation unit for an electromechanically actuated disk brake, for motor vehicles, arranged on a brake caliper (50) in which first and second brake linings (4, 5) interacting with respective lateral faces of a brake disk (6) are displaceable to a limited extent, the first brake lining (4) being engageable by the actuation unit with the brake disk (6) by means of an actuating element (7) and the second brake lining (5) engaging the brake disc through the effect of a reaction force exerted by the brake caliper (50), the actuation unit comprising an electric motor (1) and a reduction gear (2) operatively arranged between the electric motor (1) and the actuating element (7) and having a threaded spindle (17) which is driveable by means of the electric motor (1) and bears axially against the brake caliper (50), a rolling element bearing (33, 42, 63) and a force measuring device (30, 40, 60) having a deformable element (35, 43, 65) which is deformed when subjected to a force to be determined are arranged in the force flow between the threaded spindle (17) and the brake caliper (50), the threaded spindle (17) bearing against the deformable element of the force measuring device (30, 40, 60) via the rolling element bearing (33, 42, 63).

2. The actuation unit as claimed in claim 1, further comprising at least a part of the deformable element (43, 65) of the force measuring device (40, 60) and at least a part of the rolling element bearing (42, 63), are formed in one piece (43, 65).

3. The actuation unit as claimed in claim 2, further comprising the rolling element bearing (42, 63) includes a first bearing element (41, 61) and a second bearing element (43, 65) between which rolling elements (45, 63) are arranged, and in that a part of the deformable element (43, 65) of the force measuring device (40, 60) forms one of the first and second bearing elements of the rolling element bearing.

4. The actuation unit as claimed in claim 1 further comprising the rolling element bearing is in the form of a needle roller bearing (33, 63).

5. The actuation unit as claimed in claim 4, further comprising a part of the deformable element (65) of the force measuring device (60) forms a bearing disk of the needle roller bearing (63).

6. The actuation unit as claimed in claim 1 further comprising the rolling element bearing is in the form of a tapered roller bearing or a ball bearing (42).

7. The actuation unit as claimed in claim 6, further comprising a part of the deformable element (43) of the force measuring device (40) forms a ball bearing ring of the ball bearing (42) or a tapered roller bearing ring of the tapered roller bearing.

8. The actuation unit as claimed in claim 1 further comprising deformation sensors, in the form of strain gauges, are arranged on the deformable element (35, 43, 65).

9. The actuation unit as claimed in claim 1 further comprising the reduction gear (2) is in the form of a ball screw drive.
